(19) United States
(12) Patent Application Publication
(10) Pub. No.: US 2026/0317120 A1
(43) Pub. Date: Oct. 15, 2026

(54) POSITION-DETERMINING SYSTEM

(71) Applicant: INVENTIO AG, Hergiswil (CH)

(72) Inventors: Eric Birrer, Buchrain (CH); Michail Chatzimichailidis, Adliswil (CH); Steven Brossi, Glattpark (CH)

(21) Appl. No.: 19/483,417

(22) PCT Filed: May 23, 2024
(86) PCT No.: PCT/EP2024/064168

§ 371 Date: Nov. 11, 2025

(30) Foreign Application Priority Data
May 25, 2023 (EP) 23175234.6

(51) Int. Cl. B66B 1/34

(52) U.S. Cl. CPC B66B 1/3492

(57) ABSTRACT

The invention relates to a position-determining system for determining the absolute position of an elevator car that can be moved along at least one guide rail, which position-determining system has a code mark pattern and a code reading device. A bit sequence of the code mark pattern has at most a fixed number p of subsequent identical bits.

### TECHNICAL FIELD

The invention relates to a position-determining system, the use thereof, and a method for determining the absolute position of an elevator car that can be moved along at least one guide rail.

### BACKGROUND

Devices for determining the absolute position of an elevator car are known in the prior art. In addition to the elevator car, stationary code mark patterns and corresponding code reading devices fixedly attached to the elevator car are used.

WO 03/011733 A1, for example, discloses an elevator system with an absolute length measuring system for determining the car position of an elevator car movable along at least one guide rail, with a code mark pattern of a pseudorandom coding attached to the guide rail in the direction of travel. In the absolute code mark pattern, any n consecutive code marks represent a code word. The absolute code mark pattern is represented as a single-track code mark pattern of an n-digit pseudorandom sequence in Manchester coding with code marks of identical length. This has the disadvantage that two code bits are required to encode one information bit since, in Manchester coding, the state of a payload bit is represented by the change of the logical state (0 to 1 or 1 to 0) from one code bit to the next. Of the four possible sequences of two logical states (00, 01, 10 and 11), only two (01, 10) are used for payload data bits by Manchester coding. Thus, the maximum information density of a code mark pattern encoded in this way is only half as high in comparison to simple binary coding. This increases the time to determine the absolute car position to the detriment of the determination speed and/or resolution.

### SUMMARY

The object of the present invention is to reliably, quickly and precisely determine the absolute position of an elevator car that can be moved along at least one guide rail. For this purpose, a suitable position-determining system, the use thereof and a method will be specified.

This object is achieved by the subject matter of the independent claims. Advantageous developments of the subject matter of the independent claims are characterized in the dependent claims.

Accordingly, a position-determining system is provided which has a code mark pattern fixedly attached parallel to the direction of travel next to the elevator car and a code reading device, wherein the code mark pattern is formed as a bit sequence of N consecutive code marks, each representing a bit of the code mark pattern.

The code reading device further comprises a sensor attached to the elevator car and an evaluation unit, the sensor being configured to scan a sequence of code marks of the code mark pattern and to generate code mark signals from the code marks of the sequence, the code mark signals representing the respective bits of the scanned code marks.

The evaluation unit is configured to receive the code mark signals from the sensor, to obtain a code word with n consecutive bits of the scanned code marks from the received code mark signals, and to determine the absolute car position from the obtained code word. The bit sequence of the code mark pattern has at most a fixed number p of consecutive identical bits, where 2<p<n.

During operation, the sensor of the code reading device, which is attached to the elevator car and thus moves together with it, scans a sequence of code marks of the stationary code mark pattern. Scanning can occur both while the elevator car is moving and when the car is stationary.

Consecutive code marks are understood to be the code marks that each represent a bit of the code mark pattern, which are also referred to as code-word-encoding code marks. Although not intended, it is also not excluded that further code marks that do not represent such bits may be inserted between these code-word-encoding code marks. Such code marks are called non-code-word-encoding code marks. The statement that consecutive code marks are used to determine the code word therefore refers to the code-word-encoding code marks and does not fundamentally exclude non-code-word-encoding code marks inserted in between which do not play any role with respect to the invention. Herein, the terms “code marks”, “consecutive”, “bit(s) of the code mark pattern” and “bit(s) of the code word” refer (only) to code-word-encoding code marks, unless otherwise stated. The totality of code-word-encoding and non-code-word-encoding code marks is referred to as “physical code marks”.

Preferably, all physical code marks are code-word-encoding code marks. Preferably, the code marks of a code word, each representing a bit of the code mark pattern (code-word-encoding), follow one another immediately, i.e. without any further physical (e.g. non-code-word-encoding) code marks in between.

The scanned sequence of code marks particularly preferably consists of a continuous sequence of immediately consecutive individual code marks, whereby all code marks of the respective sequence are scanned by the sensor, and code mark signals are preferably generated from all code marks. In every statement regarding “consecutive” elements, it is preferred that the respective elements follow one another immediately. The code mark pattern therefore preferably consists of immediately consecutive code-word-encoding code marks. With regard to the bits of the bit sequence, “consecutive” means the immediate succession of the bits (without other bits in between), since non-code-word-encoding code marks do not contribute to the bit sequence. The bit sequence therefore has at most a fixed number p of immediately consecutive identical bits.

The code mark signals are received by the evaluation unit and interpreted as a particular one of the n consecutive bits of the code word. The n-digit code words encoded in the code mark pattern are each uniquely assigned to a single absolute car position. Preferably, the n-digit code words each represent a unique numerical code (which does not appear at any other place in the code mark pattern). Each n-digit sub-bit sequence is therefore contained in at most one position in the bit sequence of the code mark pattern. This makes it possible to assign an absolute car position to each of the n-digit code words. This means that if the code word is known, the corresponding absolute position of the elevator car can be determined based on this assignment.

Using the majority of the physical code marks, or even all of the code marks, for encoding or decoding individual bits of the code words contained in the code mark pattern increases or doubles the maximum possible information density per length interval compared to the prior art, given the same physical code mark length. The code word length can thus be selected to be shorter, for example, which allows the use of a more compact and thus less expensive sensor system or the reading of multiple code words with the same sensor reading length, which in turn increases the reliability and robustness of position determination.

The position-determining system is intended for determining the absolute position of an elevator car, in particular a passenger elevator car.

If the evaluation unit has a memory with the bit sequence of the code mark pattern and is configured to determine the absolute car position by identifying the obtained code word as a partial bit sequence of the bit sequence, the absolute car position can be determined even faster and more directly.

If the bit sequence of the code mark pattern is selected such that each partial bit sequence of n bits occurs at most once, the uniqueness of the assignment of code words to corresponding absolute car positions is ensured, and the determination of the absolute car position is particularly reliable and fast.

If the partial bit sequences are formed by means of the following steps: an output set of n-digit partial bit sequences is generated, those partial bit sequences which have more than p directly consecutive identical bits are eliminated from the output set, it is ensured that the bit sequence of the code mark pattern has at most a fixed number p of consecutive identical bits, and that the code mark pattern therefore undergoes a signal change after every p bits at the latest, thus allowing self-synchronization of the code mark pattern. This ensures that the code reading device receives a suitable reference for synchronizing the code mark pattern.

If one or each subsequent n-digit partial bit sequence overlaps the preceding n-digit partial bit sequence by n−1 bits, individual code marks can be used to encode multiple code words, thus further increasing the information density of the code mark pattern. This allows the position of the elevator car to be determined particularly quickly and/or with a high spatial resolution.

If the number p of consecutive identical bits is smaller than the number n of digits in the code words and, at the same time, n is smaller than the number N of code marks in the code mark pattern, it is ensured that a suitable reference is always available at an advantageous distance for the code reading device to be able to determine whether the currently scanned code mark represents the end or beginning of a code word.

In a non-limiting example, for illustrative purposes only, particularly preferred ranges for the parameters are as follows:
2¹⁰≤N≤2¹⁶, preferably 2¹²≤N and/or N≤2¹⁴.
8≤n≤32, preferably 16≤n and/or n≤32;
4≤p≤10, preferably 5≤p and/or p≤8.

If the code marks are either formed by optically detectable markings and the sensor of the code reading device is an optical sensor, or the code marks are formed by magnetic poles and the sensor of the code reading device is a magnetic reading head, or if the code marks are formed by different dielectric constants and the sensor of the code reading device is a sensor that detects capacitive effects, sensors that are widely used in technology and are therefore inexpensive can be used, and the position-determining system can be specifically adapted to the respective application, for example, with regard to the degree of contamination expected during operation.

If the code mark pattern is attached to the guide rail or to a tape parallel to the guide rail, preferably a PET tape, a consistent number of code marks is ensured within a distance traveled by the elevator car. This avoids inaccuracies in position determination. Possible tapes, including alternatives to a PET tape, are described in U.S. Pat. No. 4,750,592 A and can be, for example, a PET tape, a textile tape, a metal tape and/or a tape made of another plastics material such as polypropylene or a polyester (also different from PET).

If the resolution of the absolute car position corresponds to at least the length of a code mark and the length of a code mark is a maximum of 10 mm, preferably a maximum of 5 mm, particularly preferably a maximum of 2 mm, or even 1 mm, the absolute car position can be determined particularly precisely. A resolution at least as high or even higher (i.e. finer) than that corresponding to the length of a code mark can be achieved, for example, by a fine interpolation unit as described in WO 03/011733 A1, or by the method described in patent application EP 23173534.1.

If each of the 8 binary numbers of bit length 3 (or more generally, each of the 2^{r} binary numbers of bit length r with r=3, 4 or 5) occurs as a partial bit sequence in the bit sequence of the code mark pattern, the information density of the code mark pattern is particularly high, which increases the speed of position determination.

The object is further achieved according to the invention by a method for determining the absolute position of an elevator car that can be moved along at least one guide rail by means of the position-determining system according to any of claims 1 to 11, the method comprising the following steps: the code mark pattern is scanned, code mark signals are generated from a sequence of code marks of the scanned code mark pattern, a code word with n bits is determined from the generated code mark signals, wherein consecutive code marks are used to determine the code word, the corresponding absolute car position is determined from the determined code word, the determined absolute car position is output.

Carrying out the individual method steps ensures a fast, precise and reliable determination of the absolute position of the elevator car.

The object is further achieved according to the invention by the use of a position-determining system according to any of claims 1 to 11 for determining the absolute position of the elevator car. The use of a position-determining system according to the invention ensures that the absolute position of the elevator car is determined quickly, precisely and reliably.

The use of the singular shall not exclude the plural, unless otherwise disclosed.

### BRIEF DESCRIPTION OF THE DRAWINGS

Further details and features will become apparent from the following description of a preferred embodiment in conjunction with the figures. The respective features can be implemented individually or several in combination with one another. The possibilities for achieving the object are not limited to the embodiment. For example, range specifications always include all intermediate values (not mentioned) and all conceivable sub-intervals.

The embodiment is shown schematically in the figures. The same reference signs in the individual figures denote identical or functionally identical elements, or elements that correspond to one another in terms of their functions. In particular:

FIG. 1 is a schematic side view of a position-determining system according to the invention for determining the absolute position of an elevator car that can be moved along at least one guide rail; and

FIG. 2 is a schematic representation of a bit sequence of an exemplary portion of the code mark pattern of the position-determining system from FIG. 1.

### DETAILED DESCRIPTION OF EMBODIMENTS

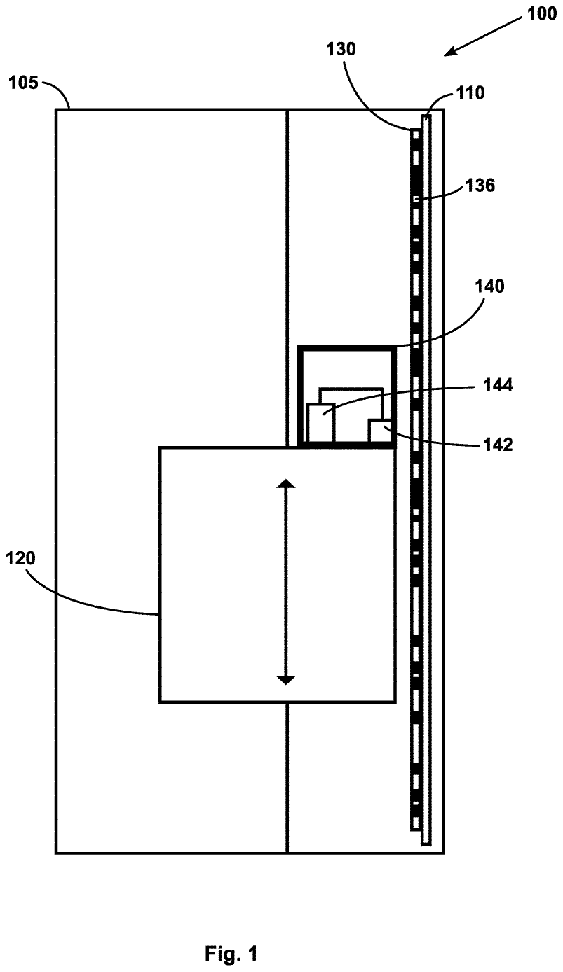

FIG. 1 shows a position-determining system 100 according to the invention for determining the absolute position of an elevator car 120 that can be moved along at least one guide rail 110 within an elevator shaft 105. The direction of travel of the elevator car 120 is symbolized by a double arrow within the elevator car 120. The position-determining system 100 has an absolute code mark pattern 130 fixedly attached parallel to the direction of travel next to the elevator car 120 and a code reading device 140. The code reading device 140 itself comprises a sensor 142 attached to the elevator car 120, preferably near the code mark pattern 130, and an evaluation unit 144 connected to the sensor 142.

Multiple sensors 142 per code reading device 140 are also conceivable, with the sensors 142 preferably being offset in the direction of travel over a range with a length greater than the length of two code marks 136 at a distance less than the length of one code mark 136 on a line that is congruent with the longitudinal axis of the code mark pattern 130, whereby multiple code marks 136 can be scanned simultaneously. This is in particular useful for scanning the code mark pattern 130 when the elevator car 120 is stationary, but also increases the reliability of the scanning process while the elevator car 120 is moving, since individual code marks 136 can be scanned sequentially by multiple sensors 142, and the corresponding code mark signals can be compared with one another.

Typically, the elevator car 120 moves up and down within a (concrete) elevator shaft 105 in a building in the direction of gravity. The fixed attachment point of the code mark pattern 130 is located, for example, in the corresponding shaft head. In the elevator shaft 105, a shift of the attachment point may occur due to shrinkage/settling of the building. The code mark pattern 130 is therefore preferably attached to a support which, unlike the elevator shaft 105 itself, does not shrink. Attaching to the guide rail 110 itself or on a tape parallel to the guide rail 110, preferably a PET tape, is conceivable here. The PET tape can be held under tension by appropriate tensioning elements (not shown in FIG. 1) and/or re-tensioned over time to counteract the effects of shrinkage described above.

Preferably, the code marks 136 of the code mark pattern 130 are formed by optically detectable markings, and the sensor 142 of the code reading device 140 is an optical sensor which can detect the optical markings. In the preferred embodiment shown in FIG. 1, the code marks 136 are formed by white and black rectangles, wherein the optical sensor 142 can detect whether a black or white rectangle is being scanned. The optical sensor 142 is, for example, an infrared sensor known from common barcode scanners.

As an alternative to optically detectable markings, the code marks 136 of the code mark pattern 130 can be formed, for example, by magnetic poles, the sensor 142 of the code reading device 140 being a magnetic read head which, for example, comprises a Hall sensor or a Reed sensor. Likewise, the code marks 136 can be formed by different dielectric constants, the sensor 142 of the code reading device 140 being a sensor that detects capacitive effects. Scanning by the sensor 142 is preferably contactless. For this purpose, the sensor 142 is preferably guided over the code mark pattern 130 at the smallest possible distance, particularly preferably at a distance of less than 1 cm. However, guidance at a greater distance from the code mark pattern 130 is also conceivable. Exemplary physical lengths of the code marks 136 are 1 mm for code marks 136 formed by optically detectable markings, 7 mm for code marks 136 formed by magnetic poles, and 8 mm for code marks 136 that are formed by different dielectric constants.

A particularly reliable position-determining system 100 can be obtained by designing the code reading device 140, including the sensors 142 and the evaluation unit 144, redundantly. In such an embodiment, the sensors 142 of the individual code reading devices 140 are preferably arranged offset in the direction of travel over a range with a length greater than the length of two code marks 136 at a distance less than the length of one code mark 136 on a line that is congruent with the longitudinal axis of the code mark pattern 130.

In addition to code reading devices 140, at least one floor sensor (not shown in FIG. 1) can be attached to the elevator car 120, which floor sensor is also moved in the elevator shaft 105 together with the elevator car 120 in order to detect floor markings arranged at floor level in the elevator shaft 105. The detected floor markings are preferably transferred to an evaluation unit 144 which evaluates them and, based on the evaluation, sends corresponding signals to a control system of the elevator car 120. In this way, it can be determined even more reliably whether, for example, it is safe to open the elevator doors or whether the visual and/or optical output of the floor designation needs to be changed and/or triggered accordingly.

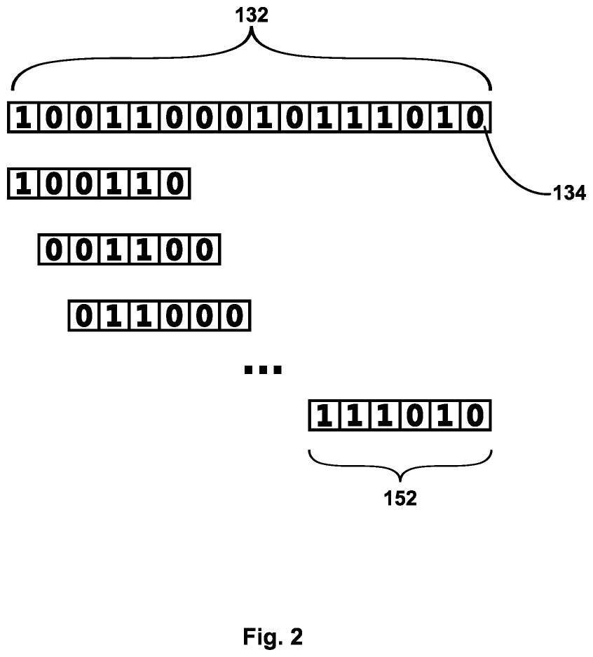

FIG. 2 shows an exemplary 16-digit portion of a bit sequence 132 of the code mark pattern 130 of the position-determining system 100 from FIG. 1. A partial bit sequence 152 consists of n=6 bits 134, with successive partial bit sequences 152 preferably overlapping at (n−1)=5 positions, thus allowing individual bits 134 of the bit sequence 132 to be assigned to multiple partial bit sequences 152. The bit sequence 132 has at most p=3 consecutive identical bits 134 so that a change between 0 and 1 or between 1 and 0 occurs after p=3 bits 134 at the latest.

In the code mark pattern 130 itself, the logical states 1 and 0 of the individual bits 134 of the bit sequence 132 are realized, for example, by optically detectable code marks 136 in the form of white or black markings, with the partial bit sequences 152 each representing a code word.

One possible method for generating a bit sequence 132 of a code mark pattern 130 according to the invention can be implemented by stringing random bits 134 together to form a random sequence, with the additional requirements for the bit sequence 132 being ensured according to the principle of trial and error. An exemplary implementation of this principle can for example be carried out as follows:
Random bits 134 are generated in a loop and, starting from a first random bit 134, are strung together to form a bit sequence 132 for the code mark pattern 130, with newly generated random bits 134 being appended to the existing bit sequence 132. After each appending of a random bit 134, the (error) conditions (1) and optionally (2) are checked:
(1) Are the last (p+1) bits 134 of the bit sequence 132 identical?
(2) Do the last b bits 134 of the bit sequence 132 already occur elsewhere as a partial bit sequence 152 of the bit sequence 132?

If one of the two conditions is met, a number of the last bits 134 of the bit sequence 132 are discarded and randomly generated again. The number of last bits 134 to be discarded can be gradually increased if the (error) conditions (1) and/or (2) are repeatedly met.

The above steps are repeated until a bit sequence 132 has been generated that has a previously defined number N of bits 134.

List of reference signs

| | |
|---|---|
| 100 | Position-determining system |
| 105 | Elevator shaft |
| 110 | Guide rail |
| 120 | Elevator car |
| 130 | Code mark pattern |
| 132 | Bit sequence |
| 134 | Bit |
| 136 | Code mark |
| 140 | Code reading device |
| 142 | Sensor |
| 144 | Evaluation unit |
| 152 | Partial bit sequence |

1-13. (canceled)

14. A position-determining system for determining an absolute position of an elevator car that can be moved along at least one guide rail, the position-determining system comprising:
a code mark pattern fixedly attached parallel to a direction of travel next to the elevator car; and
a code reading device,
wherein the code mark pattern is formed as a bit sequence of N consecutive code marks, each representing a bit of the code mark pattern, wherein N is a positive number;
wherein the code reading device has a sensor attached to the elevator car and an evaluation unit;
wherein the sensor is configured to scan a sequence of the code marks of the code mark pattern and to generate code mark signals from the code marks of the sequence, the code mark signals representing respective bits of scanned code marks;
wherein the evaluation unit is configured to receive the code mark signals from the sensor, to obtain a code word with n consecutive bits of the scanned code marks from the code mark signals received and to determine the absolute position of the elevator car from the obtained code word, wherein n is a positive number; and
wherein the bit sequence of the code mark pattern has at most a fixed number p of consecutive identical bits, where p is greater than two and less than n.

15. The position-determining system according to claim 14, wherein the evaluation unit has a memory with the bit sequence of the code mark pattern and is configured to determine the absolute position of the elevator car by identifying the obtained code word as a partial bit sequence of the bit sequence.

16. The position-determining system according to claim 15, wherein the bit sequence of the code mark pattern is selected such that each partial bit sequence of n bits occurs at most once therein.

17. The position-determining system according to claim 14, wherein the sequence of the scanned code marks is a continuous sequence.

18. The position-determining system according to claim 15, wherein the partial bit sequences are formed by generating an output set of n-digit partial bit sequences and eliminating from the output set those partial bit sequences which have more than the fixed number p of directly consecutive identical bits.

19. The position-determining system according to claim 18, wherein a subsequent n-digit partial bit sequence overlaps a preceding n-digit partial bit sequence by n−1 bits.

20. The position-determining system according to claim 14, wherein the fixed number p is less than n, and wherein n is less than N.

21. The position-determining system according to claim 14, wherein one or more of the code marks are formed by optically detectable markings, and the sensor of the code reading device is an optical sensor.

22. The position-determining system according to claim 14, wherein one or more of the code marks are formed by magnetic poles, and the sensor of the code reading device is a magnetic read head.

23. The position-determining system according to claim 14, wherein the code marks are formed by different dielectric constants, and the sensor of the code reading device is a sensor that detects capacitive effects.

25. The position-determining system according to claim 14, wherein the code mark pattern is attached to the guide rail or to a tape parallel to the guide rail, and wherein the tape is a PET tape.

26. The position-determining system according to claim 14, wherein a resolution of the absolute position of the elevator car is less than or identical to a length of the code mark, and wherein the length of the code mark is one of a maximum of 10 mm, a maximum of 5 mm, or a maximum of 1 mm.

27. The position-determining system according to claim 14, wherein each of one or more binary numbers of bit length 3 occurs as a partial bit sequence in the bit sequence of the code mark pattern.

28. A method for determining an absolute position of an elevator car that can be moved along at least one guide rail, the method comprising:
providing a position-determining system;
scanning a code mark pattern;
generating code mark signals from a sequence of code marks of the code mark pattern;
determining a code word with n bits from the code mark signals, wherein n is a positive number;
determining the absolute position of the elevator car corresponding with the code word; and
outputting the absolute position of the elevator car.

29. A method for determining an absolute position of an elevator car that can be moved along at least one guide rail, the method comprising:
providing a position-determining system, the position-determining system comprising:
a code mark pattern fixedly attached parallel to a direction of travel next to the elevator car; and
a code reading device,
wherein the code mark pattern is formed as a bit sequence of N consecutive code marks, each representing a bit of the code mark pattern, wherein N is a positive number; and
wherein the code reading device has a sensor attached to the elevator car and an evaluation unit;
scanning the code mark pattern;
generating code mark signals from a sequence of code marks of the code mark pattern;
determining a code word with n bits from the code mark signals, wherein n is a positive number;
determining the absolute position of the elevator car corresponding with the code word; and
outputting the absolute position of the elevator car.
